(19) United States
(12) Patent Application Publication
(10) Pub. No.: US 2024/0050201 A1
(43) Pub. Date: Feb. 15, 2024

(54) MODULAR DENTAL IMPLANT

(71) Applicant: MAXON INTERNATIONAL AG, Sachseln (CH)

(72) Inventor: Thorsten BUURLAGE, Gorxheimertal (DE)

(21) Appl. No.: 18/258,034

(22) PCT Filed: Dec. 17, 2021
(86) PCT No.: PCT/EP2021/086633

§ 371 Date: Jun. 16, 2023

(30) Foreign Application Priority Data
Dec. 18, 2020 (EP) 20215762.4

(51) Int. Cl. A61C 8/00; A61C 13/00

(52) U.S. Cl. CPC A61C 8/0012; A61C 8/0037; A61C 8/0068; A61C 13/0006; A61C 2008/0046

(57) ABSTRACT

An abutment (3) for a modular dental implant (1) wherein the modular dental implant (1) comprises a main part (2) that can be anchored in a jawbone and is made of a metal material suitable for implants; and comprises the abutment (3), which is intended to be connectable to the main part (2) of the modular dental implant (1).

The abutment (3) is made of a ceramic material suitable for implants (3). The surface (31) in a contact region (5) of the abutment (3) is intended to contact a surface (21) in a contact region (5′) of a main part (2), or to lie on the surface (21) in the contact region (5′) of the main part (2), when the modular dental implant (1) is in an assembled state. The surface (31) of the abutment (3) in the aforementioned contact region (5) of the abutment (3) is processed in such a way that the surface (31) has a roughness average Ra which, when the modular dental implant (I) is in operation, prevents damage, in particular the removal of material, by the abutment (3) to the surface (21) of the main part (2) in the aforementioned contact region (5′) of the main part (2).

### TECHNICAL FIELD

The invention relates to an abutment for a modular dental implant, a corresponding manufacturing method, a main part for a modular dental implant, and a modular dental implant.

### TECHNOLOGICAL BACKGROUND

Dental implants can be designed in one piece and in multiple parts. In general, multi-part dental implants have established themselves due to their advantages over single-piece dental implants. Multi-part dental implants can be better adapted to the specifically intended use and provide better protection against undesirable loads during the healing process.

The multi-part dental implants known from the prior art are frequently constructed in three parts and comprise a main part to be inserted into a jawbone, an abutment to be fastened to the main part, and a superstructure to be placed on the abutment. The main part, also known as an implant body, is intended to functionally replace the tooth root and is usually cylindrical or conical. As a rule, the main part has a thread, via which the main part can be fastened by screwing into the jawbone. The abutment also known as an implant abutment or abutment serves as a pontic between the main part and the superstructure and is usually screwed and/or glued into the main part. The superstructure represents the actual dental prosthesis, generally in the form of a crown or bridge, or also a prosthesis. A dental implant can also have two or more main parts for anchoring a superstructure, for example in bridges and prostheses. The main part and the abutment are embedded in the jaw or are covered by the superstructure. The superstructure itself is exposed in the oral cavity.

A modular dental implant is known, for example, from US 2019/0222386 A1.

Preferably, biocompatible and/or bioinert materials are used in dental prostheses. Titanium or titanium alloys, and ceramic materials, in particular zirconium oxide ceramic, are very frequently used. In particular, the main part of a dental implant is advantageously manufactured from such a bioinert material so that the main part can be inserted into the patient with as few complications as possible and, in particular, receding of the gum or bone tissue can be avoided. Both the material and the structure of the main part should enable a high degree of osseointegration and periointegration. The aforementioned requirements with respect to high biocompatibility and bioinertness also apply to the abutment and the superstructure.

The advantage of using titanium for implants that are inserted into the jawbone lies in the biocompatibility, which has been well documented over decades. Implant bodies comprising titanium have as little effect on the patient's body as possible. Furthermore, the metal titanium has the advantage of being tough or non-brittle. At the same time, however, it also has the disadvantage that it can be perceived as a foreign body in the oral cavity due to its dark gray coloration. Titanium is therefore preferably used for dental implants used in the jawbone, which are covered by the gum and thus not visible in the oral cavity.

Ceramic parts likewise have very good biocompatibility and are thus well tolerated by the body. The advantage of ceramic is that the ceramic can have a coloration which largely corresponds to the natural tooth coloration and thus is perceived less or not at all as a foreign body in the oral cavity. Furthermore, the absence of metal is also increasingly of interest due to the avoidance of allergies. Ceramic parts are preferably used for the tooth structure and other parts that are visible in the oral cavity, such as, for example, abutment, healing components, locators, etc.

Furthermore, a reliable connection of the abutment and the main part that is sealed against bones and gums is important for the long term success of a dental implant. A lack of connection between the abutment and the main part can lead to loosening or damage of the dental implant. Untight connections enable bacteria to penetrate the implant, which can lead to periimplantitis and can thus lead to atrophy of the jawbone, for example.

Furthermore, the forces occurring in the dentition place high demands on material and construction. For example, dental implants must be able to absorb all the high forces that occur in the denture, without breaking, cracking or loosening.

Ceramic, in particular zirconium oxide, is significantly harder than titanium. Conventional processing methods result in ceramic parts having fine sharp-edged structures on the surface. If elements made of ceramic and titanium contact, the surface of the titanium can be damaged by the sharp-edged surface structures of the ceramic. This is true, in particular, because dental implants are exposed to strong forces, for example during chewing, and a slight movement of the elements relative to one another cannot be avoided.

These can be, in particular, relative rotational movements about the longitudinal axis of the main part or the abutment, as well as relative axial movements. The titanium implant is then continuously damaged, in particular, by the chewing movements. It is therefore known in the case of a dental implant that, where possible, ceramic and metal materials should not have any contact surfaces or contact points relative to one another, in particular if abrasion from the contact surfaces, in the form of very fine titanium chips, can pass into the oral cavity and thus into the body of the patient.

DE 102010019582 A1 discloses a multi-part dental implant having a post section and an abutment. The two parts are made of metal or ceramic and are connected by means of a screw. To achieve a smooth and functional rotational self-centering of the two parts, which is only achieved by tightening the connection screw, the friction between the contact surfaces is reduced by surface coating one or both contact surfaces. The use of lubricant and polishing has been shown to be inadequate.

There is a general need for improvement in this field.

### DESCRIPTION OF THE INVENTION

The object of the invention is to provide an abutment for a modular dental implant which does not have the aforementioned and other disadvantages.

In particular, such an abutment for a modular dental implant should facilitate a combination with a metal main part to form a modular dental implant.

Such a modular dental implant should be reliable, durable and well tolerated.

These and other objects are achieved by an abutment according to the invention for a modular dental implant, a main part according to the invention for a modular dental implant, a modular dental implant according to the invention, and a production method according to the invention, according to the independent claims. Further advantageous embodiments can be found in the dependent claims and the description.

The solution according to the invention can be further improved by various embodiments which are advantageous in themselves and, unless stated otherwise, can be combined with one other as desired. These embodiments and the advantages associated with them are discussed below.

A first aspect of the invention relates to an abutment for a modular dental implant.

In the case of an abutment for a modular dental implant, wherein the modular dental implant comprises: a main part, which can be anchored in a jawbone and is manufactured from a metal material suitable for implants, and the abutment, which is provided to be connected to the main part of the modular dental implant, the abutment is manufactured from a ceramic material suitable for implants. The surface is provided in a contact region of the abutment to contact a surface in a contact region of a main part or to lie on the surface in the contact region of the main part, when the modular dental implant is in an assembled state. The surface of the abutment in the mentioned contact region of the abutment is machined in such a way that the surface has a roughness average Ra which, when the modular dental implant (1) is in operation, prevents damage, in particular the removal of material, by the abutment to the surface of the main part in the mentioned contact region of the main part.

A large contact surface between the main part and the abutment of a modular dental implant is advantageous because it leads to greater static friction between the two elements and at the same time to a lower surface pressure. This leads to greater stability of the assembled dental implant. A large contact surface also leads to less contact pressure when the acting force is the same. This results in lower shear forces during the relative movements of the main part and the abutment that occur during use of the dental implant, which likewise reduces the undesired mechanical material removal. However, the contact surface between the main part and the abutment should not be too large either since a smaller contact surface leads to higher contact pressure when the acting force is the same. Higher contact pressure achieves a bacteria-tight delimitation between the oral cavity of the patient and an interior of the implant. The contact pressure should therefore be at least so great that a bacteria-tight seal is ensured.

An abutment according to the invention advantageously consists of zirconium oxide, in particular of yttrium-stabilized zirconium oxide.

Such advantageous components make it possible to use two advantageous materials in combination for a modular dental implant, namely the metal material, in particular titanium, of a main part and the ceramic material, in particular zirconium oxide, of an abutment, without the problems known from the prior art occurring in the case of direct contact. Due to the inventive titanium-friendly configuration of the ceramic surface of the abutment in the contact region, the substantially harder ceramic material of the abutment does not erode the metal surface of the main part. This can be achieved by rounding the sharp-edged grains of the ceramic material.

Advantageously, in an abutment according to the invention, the roughness average Ra of the surface of the abutment (3) in the contact region is ≤0.08 micrometers, advantageously ≤0.04 micrometers, and particularly advantageously ≤0.02 micrometers.

In an advantageous variant, the roughness average Ra in the contact region of the abutment is between 0.02 and 0.04 micrometers.

The arithmetic mean roughness Ra is standardized by DIN EN ISO 4287:2010.

The surface of the abutment in the contact region can be coated, for example metal vapor coated or plasma coated.

The surface of the abutment in the contact region can also be glazed. A glaze can be achieved by applying one or more glaze layers to the ceramic part with subsequent melting. Another possibility is the application of a substance or a substance mixture, for example a salt, to the surface of the ceramic part, which reduces the melting point of the ceramic material locally below the sintering temperature, so that a corresponding glass layer is produced. Such a substance can also be applied via the gas phase.

Due to the smoother surface of the abutment in the contact region, the abrasion of the surface of the main part lying in the contact region is smaller.

Advantageously, an abutment according to the invention in the contact region has no edges.

Advantageously, in the case of an abutment according to the invention in the contact region, the surface of the abutment is continuous and/or rounded.

Advantageously, in an abutment according to the invention, the surface of the abutment in the contact region has a geometric continuity G1 (tangential continuity).

A G1 continuity of the surfaces in the contact region means, in particular, that there are no edges (continuity G0) on any of the surfaces in the contact region, which, in the case of an even small relative displacement of the elements or components of a modular dental implant with respect to one another, can hook into the opposite surface and shear the material off, or can be particularly easily sheared off themselves.

Particularly advantageously, in the case of an abutment according to the invention, the surface of the abutment in the contact region has geometric continuity G2 (curvature continuity).

Such a G2 continuity of the surfaces in the contact region has the advantage that, in the case of a small relative displacement of the elements or components of a modular dental implant relative to one another, the contact pressure remains approximately constant. The uniformly acting forces lead to a reduced asymmetrically acting mechanical force effect and thus also to a reduction in the mechanically caused material removal at the surface.

In an advantageous embodiment of an abutment according to the invention, the surface of the abutment is polished in the contact region.

In the method according to the invention discussed below, the polishing of the abutment is discussed in more detail.

An assembly according to the invention is advantageously produced by means of powder injection molding methods.

Due to the advantageously very smooth surface of the injection mold, the powder injection molding of such a ceramic component or element leads to a substantially smoother surface of the ceramic part produced therein by means of powder injection molding than is possible with subsequent subtractive machining methods, in particular machining processes, such as milling, grinding or drilling. This primary forming of the ceramic part without mechanical material removal thus avoids the corresponding machining tracks, which otherwise increase the roughness average Ra. In addition, subtractive machining methods can load the material structure of the ceramic component and thus lead to damage in the material structure such as, for example, stresses or cracks. The strength of the ceramic part can be reduced by such damage. In ceramic powder injection molding, this risk of damage does not exist or is significantly lower.

Advantageous free forms on the elements or components of a modular dental implant are also substantially easier to produce by means of powder injection molding than with the aforementioned subtractive machining methods.

In a further advantageous embodiment of a dental implant according to the invention, the abutment has a projection which, in the assembled state of the dental implant, is inserted into a recess of the main part.

A second aspect of the invention relates to a method for producing an abutment for a modular dental implant, wherein the modular dental implant comprises: a main part, which can be anchored in a jawbone and is manufactured from a metal material suitable for implants, and an abutment, which is provided to be connected to the main part of the modular dental implant.

Such a method according to the invention comprises the steps of:
providing a sintered ceramic abutment, for example comprising zirconium oxide;
treating a surface of the ceramic abutment at least in a contact region of the abutment in which, when the modular dental implant is in an assembled state, the abutment and the main part of the modular dental implant contact, or in which the main part of the modular dental implant and the abutment are arranged adjacent to one another;

The surface in the mentioned contact region of the abutment is machined in such a way that the surface has a roughness average Ra which, when the modular dental implant is in operation, prevents damage, in particular the removal of material, by the abutment to the surface of the main part of the modular dental implant.

In such a method according to the invention, the surface of the abutment is advantageously machined in the contact region such that the surface has a roughness average Ra 0.08 micrometers, advantageously 0.04 micrometers, and particularly advantageously 0.02 micrometers.

In an advantageous variant, the roughness average Ra is between 0.02 and 0.04 micrometers.

A reduction in the roughness average can be achieved by rounding, smoothing, blasting or polishing the sharp-edged ceramic surface

In an advantageous embodiment of the method, the surface of the abutment is polished in the contact region.

The polishing in the contact region is advantageously carried out by vibratory grinding, brushing, or lapping.

Vibratory grinding is a mechanical-chemical method for deburring, rounding, smoothing, or polishing individual parts and series parts. With such a vibratory grinding process, the loose workpieces are brought into a movement relative to the grinding wheels or polishing wheels by vibration and circulatory motions, as a result of which surfaces are smoothed. The abutments, which consist of a ceramic material, can thus be ground and polished by means of vibratory grinding.

The vibratory grinding process can take place, for example, in a round vibrator. Round vibration devices are offered by various manufacturers, such as, for example, RÖSLER Oberflächentechnik GmbH or Walther Trowal GmbH & Co. KG. The manufacturers mentioned also provide the consumables, such as grinding wheels, compounds and additives necessary for the operation of said devices.

For example, a roughness average Ra according to the invention can be achieved on the surface of the ceramic part by a prolonged vibratory grinding process of at least 48-72 hours. When the modular dental implant is in operation, such a roughness average prevents damage, in particular the removal of material, by the abutment to the surface of the main part in the mentioned contact region.

To achieve the corresponding roughness average, grinding wheels are added to the workpieces to be machined, in this case the abutments, in the vibratory grinding process. Preferably, the shape of the grinding wheels is matched to the geometry of the surface of the workpieces. Care must be taken here that all substantial contours are reached and that no jamming can arise between the grinding wheels or grinding wheels and workpieces. The grinding wheels can have flat, round or pointed shapes. The grinding wheels can also polish angular surfaces of the workpieces using pointed shapes. Using flat or round shapes avoids angular regions of the surface of the workpieces being polished.

Advantageously, the polishing stones for vibratory grinding are shaped such that they are suitable for gripping the surfaces to be polished well.

The grinding wheels influence the grinding behavior due to their shape. Curved, round shapes work less aggressively than angular grinding wheel geometries. In principle, it can be said that the larger and heavier the grinding wheels, the more intense and greater the grinding performance and the coarser and rougher the grinding pattern.

The grinding wheels for vibratory grinding of the surface of the abutment in the contact region can be manufactured from ceramic, such as aluminum oxide. Preferably, the ceramic of the grinding wheel sis harder than the abutments to be polished. However, grinding wheels made of plastic, stone or metal, such as brass or stainless steel, can also be used for the vibratory grinding process.

The size difference between the ceramic abutments and the grinding bodies is advantageously selected such that a simple separation of workpieces and grinding wheels according to size is made possible after the vibratory grinding process.

Advantageously, in such a method according to the invention, a polishing agent is additionally used during polishing, to which an grinding powder is optionally added.

The polishing agent, also called compound or treatment agent, can consist of a soapy or oily liquid. The polishing agent keeps the surface of grinding wheel sand workpieces clean and the vibratory grinding process is kept at a constant quality. If grinding powder is additionally added to the polishing agent, it is distributed uniformly on the grinding wheels by the polishing agent, thereby optimizing the polishing process.

For example, diamond powder or ceramic powder is suitable as grinding powder, which can additionally be admixed with the vibratory grinding process. The ceramic powder can consist, for example, of aluminum sulfide, silicon nitride, zirconium oxide, boron carbide or boron nitride. The grinding powder can also be contained in the grinding wheels. Various grinding powders can also be mixed.

The polishing agent/compound is selected according to the material to be processed, as well as the intended machining target. A possible compound for the vibratory grinding process for the advantageous abutments disclosed is ARF-S or M10 from Walther Trowal or IMR4 from ROSLER. The ingredients of the compounds are not published by the manufacturers. Usually, liquid compounds are used since they best meet the requirements for modern dosing systems. However, the vibratory grinding process can also be supplemented in individual cases by pulverulent or pasty compounds.

Additives which additionally enhance the grinding performance can also be supplied. The additives are added in batches at about 0.5-1.0 kg per 100 kg of grinding wheel.

In a method according to the invention, the ceramic abutment is advantageously produced by means of powder injection molding methods.

Due to the very smooth surface of the injection mold, the powder injection molding of a ceramic component or element leads to a substantially smoother surface of the ceramic part produced therein by means of powder injection molding than is possible with subtractive machining methods, in particular subtractive machining methods, such as milling or drilling. In addition, subtractive machining methods can load the material structure of the ceramic component and thus lead to damage in the material structure such as, for example, stresses or cracks. The strength of the ceramic part can be reduced by such damage. In ceramic powder injection molding, this risk of damage does not exist or is significantly lower.

Advantageous free forms on the components are also substantially easier to produce than with the aforementioned subtractive machining methods.

A third aspect of the invention relates to a main part for a modular dental implant.

A main part according to the invention for a modular dental implant is provided for this purpose to be anchored in a jawbone and connected to an abutment of a dental implant. The main part is manufactured from a metal material suitable for dental implants. The surface of the main part is provided in a contact region of the main part to contact a surface of the abutment of the dental implant in a contact region of the abutment or to lie on the surface in the contact region of the abutment, when the modular dental implant is in an assembled state.

In the case of such a main part according to the invention, the surface of the main part is advantageously continuous and/or rounded in the contact region.

Alternatively or additionally, such a main part according to the invention has no edges in the contact region.

In the case of a main part according to the invention, the surface of the main part in the contact region advantageously has geometric continuity G1 (tangential continuity). Particularly advantageously, the surface of the main part in the contact region has geometric continuity G2 (curvature continuity). Reference is made to the corresponding statements in connection with the abutment.

Advantageously, the surface of a main part according to the invention is coated in the mentioned contact region, for example plasma-coated or enameled, and/or cured or anodized.

A cured surface of the metal of the main part leads to less abrasion on the metal part resulting from the contact with the harder ceramic abutment in the contact region. The type of coating or curing is advantageously selected such that the resulting hardness of the surface of the main part in the contact region is similar to the hardness of the surface of an abutment in the contact region. This results in the abrasion of the metal main part being minimized.

An enamel coating of the main part in the contact region leads to a smoothness of the surface, which does not give projecting structures on the abutting surface of an abutment in the contact region any opportunity to hook in and thus to shear off material.

Advantageously, such a main part according to the invention consists of titanium or a titanium alloy.

In a further embodiment, the main part can consist of ceramic material. In such an embodiment, the statements regarding the surface in the contact region of the abutment also apply to the surface in the contact region of the main part.

A fourth aspect of the invention relates to a modular dental implant.

A modular dental implant according to the invention has a main part according to the invention that can be anchored in a jawbone, as well as an abutment according to the invention that can be connected to the main part.

The surface of the abutment is machined in the contact region in such a way that, depending on the hardness of the metal material of the main part and the hardness of the ceramic material of the abutment, it has a roughness average Ra which, when the dental implant is in operation, prevents or largely excludes damage by the abutment to the surface of the main part in the mentioned contact region, in particular material removal by cutting.

A large contact surface between the main part and the abutment is advantageous because it leads to a higher static friction between the two elements and at the same time to a lower surface pressure. This leads to greater stability of the assembled dental implant. A large contact surface also leads to less contact pressure when the acting force is the same. This results in lower shear forces during the relative movements of the main part and the abutment that occur during use of the dental implant, which likewise reduces the undesired mechanical material removal. However, the contact surface between the main part and the abutment should not be too large either since a smaller contact surface leads to higher contact pressure when the acting force is the same. Higher contact pressure achieves a bacteria-tight delimitation between the oral cavity of the patient and an interior of the implant. The contact pressure should therefore be at least so great that a bacteria-tight seal is ensured.

Dental implants according to the invention make it possible to use two advantageous materials, i.e., the metal material, in particular titanium, and the ceramic material, in particular zirconium oxide, in combination for the dental implant, without the problems known from the prior art occurring in the case of direct contact. Due to the inventive titanium-friendly configuration of the ceramic surface in the contact region of the abutment, the substantially harder ceramic material does not erode the metal surface in the contact region of the main part.

Advantageously, in a dental implant according to the invention, the surface of the harder component or element is rounded in the contact region between the abutment and the main part.

In an advantageous embodiment of a dental implant according to the invention, the abutment has a projection which, in the assembled state of the dental implant, is inserted into a recess of the main part.

The main part and/or the abutment of a dental implant according to the invention advantageously consist of two or more elements or components.

Advantageously, in the assembled state of a dental implant according to the invention, a non-rotatable form fit exists between the main part and the abutment.

In an advantageous embodiment of a dental implant according to the invention, the main part and the abutment are connected to a connecting screw when the dental implant is in the assembled state.

Further aspects of the present invention also emerge from the following description.

### BRIEF DESCRIPTION OF THE DRAWINGS

The dental implant according to the invention is explained below with reference to drawings.

FIG. 1 schematically shows a longitudinal section through a possible embodiment of a dental implant according to the invention.

FIG. 2 schematically shows a detail view from the longitudinal section of FIG. 1, in which the contact region between the main part and the abutment is shown.

FIG. 3 schematically shows a longitudinal section of the dental implant from FIG. 1 in an exploded view.

### WAYS OF IMPLEMENTING THE INVENTION

The examples given below serve to better illustrate the invention, but are not capable of limiting the invention to the features disclosed herein.

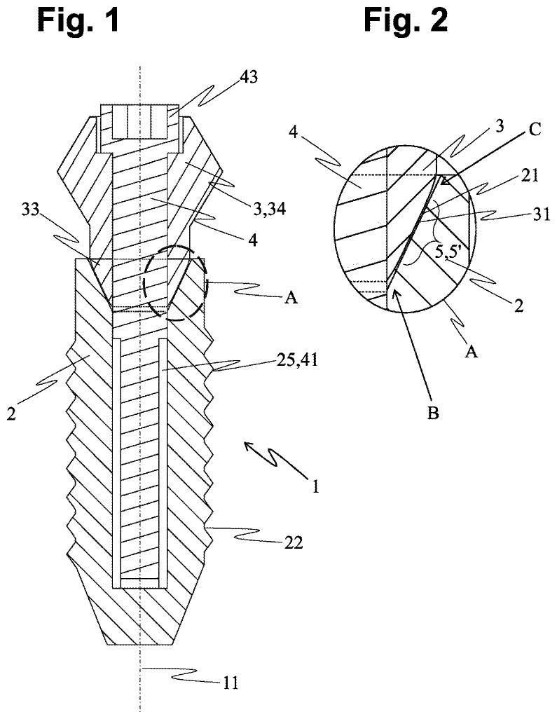

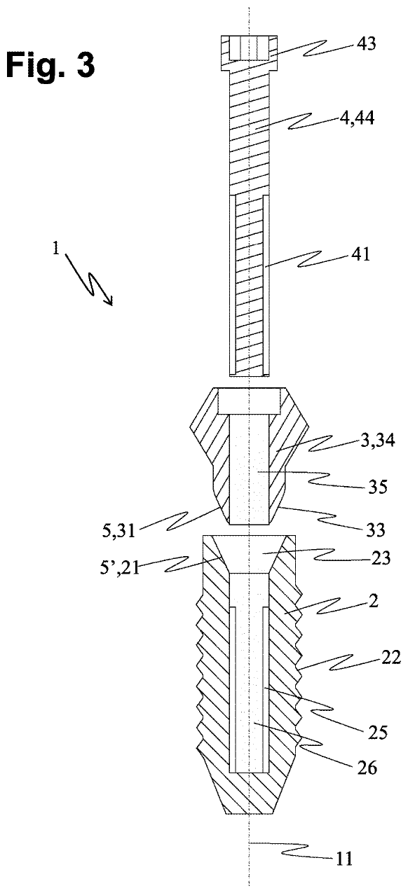

An advantageous embodiment of a dental implant 1 according to the invention is shown in FIGS. 1, 2 and 3. The dental implant 1 consists of a metal main part 2 and a ceramic abutment 3, which are operatively connected along the longitudinal axis 11 by a connecting screw 4.

The main part 2, which is provided to be permanently fastened in a jawbone, has an external thread 22, with which the main part 2 can be screwed into a previously drilled blind hole in the jawbone during implantation. The external thread 22 of the main part 2 can be selected appropriately depending on whether a thread has previously been cut into this blind hole or not. For example, the external thread can be designed as a cutting thread so that a separate internal thread does not have to be attached in the hole in the jawbone.

A substantially cylindrical blind hole 26, which is open towards the coronal longitudinal end, is arranged in the main part 2 in alignment with the longitudinal axis 11, with an internal thread 25 which is provided to interact with an external thread 41 of a connecting screw 4 in the assembled state of the dental implant 1.

The blind hole 26 of the main part 2 expands towards the outside to form a concave recess 23 formed substantially as a hollow cone. When the dental implant 1 is in the assembled state, the conical lateral surface of the conical apical projection 33 of the ceramic abutment 3 lies on the conical lateral surface of the recess 23.

The advantage of the conical shape of the recess 23 and projection 33 is that a self-centering of the main part and the abutment 3 along the longitudinal axis 11 takes place during assembly of the dental implant 1. At the same time, the clearance between the main part and the abutment is minimized both in the longitudinal direction 11 and transversely thereto. This is advantageous in terms of avoiding abrasion.

The abutment 3 comprises a body 34 with a continuous hole 35. At the apical end of the abutment, a substantially conically shaped projection 33 is arranged, which in the assembled state of the dental implant 1 is flush in the conical recess 23 of the main part. A depression in which the screw head 43 of the connecting screw 4 lies is arranged on the coronal end of the abutment.

The surfaces 21, 31 of the conical lateral surfaces of the recess 23 and the projection 33, which surfaces 21, 31 come into contact during normal operation of the dental implant 1, define the contact region 5 or 5′. Recess 23 and projection 33 are designed such that the contact surface is as large as possible and substantially conical.

A large contact surface leads to a higher shape-related positioning and thus to a greater stability of the assembled implant. Furthermore, a large contact surface leads to higher static friction and thus also to greater stability of the assembled implant. At the same time, a large contact surface leads to relatively lower contact pressure, and thus to lower frictional forces, and thus to less undesired mechanical material removal.

However, the contact surface should also not be selected too large because a small contact surface results in a higher contact pressure when the acting force is the same. The higher contact pressure achieves a good bacteria-tight delimitation between the oral cavity of the patient and an interior of the implant. The contact surface is therefore advantageously sufficiently small that the resulting contact pressure ensures a bacteria-tight seal.

At the same time, in the exemplary embodiment shown, the recess 23 and the projection 33, and in particular the surfaces thereof in the contact regions 5, 5′, are designed such that the surface is continuous, i.e., does not have any edges or seams. Such edges and seams are problematic with respect to the mechanical abrasion. The edges of the harder ceramic abutment can penetrate the softer metal material of the main part and shear off material during a relative movement of the surfaces that lie on top of one another. Conversely, edges on the softer main part can be more easily sheared off by the ceramic material. Continuous surfaces minimize this source of mechanical material removal.

In the example shown, the recess 23 of the main part 2 is conical. In the case of the projection 33 of the abutment 3, the contact region 5 is likewise conical, matching the shape of the recess 23. On the apical end of the projection 33, on the other hand, the pitch of the cone surface in relation to the longitudinal axis 11 decreases in an edge region of the contact surface 5 so that a steadily increasing gap is produced between the surface 5′ of the recess 23 and the surface 5 of the projection 33 towards the longitudinal axis 11 (cf. arrow B in FIG. 2). Similarly, on the coronal end of the projection 33 in an edge region of the contact surface, the pitch of the cone surface increases with respect to the longitudinal axis 11 so that a continuously increasing gap is likewise produced (cf. arrow C in FIG. 2). As a result of this embodiment of the contact region 5, 5′, there are no edges at the end of the contact region 5, 5′ of the recess 23 and the projection 33 which can scrape material or which can be sheared off.

In a different embodiment, not shown, the surface of the recess 23 can alternatively or additionally be configured such that, towards an apical end of the recess, the angle of inclination of the conical surface of the recess 23 increases relative to the longitudinal axis 11 and, towards a coronal end of the recess, the angle of inclination of the conical surface of the recess 23 decreases relative to the longitudinal axis 11 so that a continuously increasing gap between the recess 23 and the projection 33 likewise results at the ends of the contact region 5, 5′.

In the two aforementioned embodiments, the surfaces of the main part 2 and the abutment 3 in the contact region 5′, 5 have at least geometric continuity G1. The geometric continuity G2, as in the example shown in the figures, is particularly advantageous.

A connection screw 4 is used for the form-fitting and force-fitting connection of the main part 2 and the abutment 3 of the dental implant 1. The connecting screw 4 comprises a cylindrical bolt 44 having an external thread 41 and a screw head 43. In the example shown, the screw head has a concave depression for a hexagonal wrench so that the screw can be screwed in and out. Other possibilities for operatively connecting a screw with a screwing tool are also known to the person skilled in the art.

The connecting screw 4 is advantageously made of metal, but it can also be made of ceramic. Ceramic screws, however, are significantly more sensitive to shearing forces.

The inner diameter of the through hole 35 of the abutment 3 is selected such that, when the dental implant 1 is in the assembled state, the non-threaded section of the screw bolt 44 lies flush in the through hole 35. The screw 4 draws the main part and the abutment together with a certain tensile force, so that the conical projection 33 of the abutment 3 is pressed into the complementary conical depression 23 of the main part 2. This results in a fixed and non-positive connection between the main part 2 and the abutment 3, which at the same time also seals the interior of the dental implant consisting of blind hole 26 and through hole 35 in relation to the connection between the main part and the abutment.

A superstructure, for example a ceramic tooth crown, can then be mounted on the assembled modular dental implant 1 as shown in FIG. 1, for example by gluing. Advantageously, this superstructure closes the abutment 3 in a sealing manner towards the outside, so that the connecting screw 4 comes to lie completely within the modular dental implant 1.

The present invention is not limited in scope to the specific embodiments described herein. Rather, a person skilled in the art can find in the description and the corresponding figures various further modifications of the present invention, which also fall within the scope of the claims, in addition to the examples disclosed herein. In addition, various references are cited in the description, the disclosure content of which is hereby included in its entirety by reference in the description.

### LIST OF REFERENCE SIGNS

1 Dental implant
11 Longitudinal axis
2 Main part
21 Surface of the main part in the contact region
22 External thread
23 Recess
25 Internal thread
26 Blind hole
3 Abutment
31 Surface of the abutment in the contact region
33 Projection
34 Body of the abutment
35 Through hole
4 Connecting screw
41 External thread
43 Screw head
44 Screw bolt
5 Contact region of the abutment
5′ Contact region of the main part

1. An abutment for a modular dental implant, the modular dental implant comprising:
a main part, which can be anchored in a jawbone and is made of a metal material suitable for implants, and
the abutment, which is intended to be connectable to the main part of the modular dental implant;
wherein the abutment is made of a ceramic material suitable for implants;
wherein the surface is intended in a contact region of the abutment to contact a surface in a contact region of the main part, or to lie on the surface in the contact region of the main part, when the modular dental implant is in an assembled state; and
wherein the surface of the abutment in the mentioned contact region of the abutment is machined such that the surface has a roughness average Ra which, when the modular dental implant is in operation, prevents damage, in particular the removal of material, by the abutment to the surface of the main part in the mentioned contact region of the main part.

2. The abutment according to claim 1, wherein the roughness average Ra of the surface of the abutment in the contact region is 0.08 micrometers, advantageously 0.04 micrometers, and is particularly advantageously 0.02 micrometers.

3. The abutment according to claim 1, wherein the abutment has no edges in the contact region.

4. The abutment according to claim 1, wherein the surface of the abutment is continuous and/or rounded in the contact region.

5. The abutment according to claim 1, wherein the surface of the abutment has G1 continuity in the contact region, and advantageously G2 continuity.

6. The abutment according to claim 1, wherein the surface of the abutment is polished in the contact region.

7. The abutment according to claim 1, wherein the abutment is produced by means of powder injection molding methods.

8. A method for producing an abutment for a modular dental implant, wherein the modular dental implant comprises: a main part, which can be anchored in a jawbone and is made of a metal material suitable for implants, and an abutment, which is intended to be connected to the main part of the modular dental implant;
the method comprising the steps of:
providing a sintered ceramic abutment, for example comprising zirconium oxide;
treating a surface of the ceramic abutment at least in a contact region of the abutment in which, when the modular dental implant is in the assembled state, the abutment and the main part of the modular dental implant contact, or in which the main part of the modular dental implant and the abutment are arranged adjacent to each other;
wherein the surface in the mentioned contact region of the abutment is machined such that the surface has a roughness average Ra which, when the modular dental implant is in operation, prevents damage, in particular the removal of material, by the abutment to the surface of the main part of the modular dental implant.

9. The method according to claim 8, wherein the surface of the abutment in the contact region is machined such that the surface has a roughness average Ra 0.08 micrometers, advantageously 0.04 micrometers, and particularly advantageously 0.02 micrometers.

10. The method according to claim 8, wherein the surface of the abutment is polished in the contact region.

11. The method for producing an abutment according to claim 10, wherein the polishing in the contact region takes place by vibratory grinding, lapping or brushing.

12. The method according to claim 10, wherein a polishing agent is additionally used during polishing.

13. The method according to claim 12, wherein a grinding powder is additionally added to the polishing agent.

14. The method according to claim claim 10, wherein polishing stones made of ceramic, stone, plastic or metal are used for vibratory grinding.

15. The method according to claim 10, wherein the polishing stones are shaped such that they are suitable for gripping the surfaces to be polished well.

16. The method according to claim 8, wherein the abutment is produced by means of powder injection molding methods.

17. A main part for a modular dental implant, which is intended for the purpose of being anchored in a jawbone and being connected to an abutment of a dental implant;
wherein the main part is made of a metal material suitable for dental implants; and
wherein the surface of the main part is intended in a contact region of the main part to contact a surface of the abutment of the dental implant in a contact region of the abutment, or to lie on the surface in the contact region of the abutment, when the modular dental implant is in an assembled state.

18. The main part according to claim 17, wherein the surface of the main part is continuous and/or rounded in the contact region of the main part.

19. The main part according to claim 17, wherein the main part has no edges in the contact region.

20. The main part according to claim 17, wherein the surface of the main part has G1 continuity in the contact region, and advantageously G2 continuity.

21. The main part according to claim 17, wherein the surface of the main part is coated, hardened and/or anodized in the contact region.

22. A modular dental implant,
having a main part, which can be anchored in a jawbone, according to claim 17, and
having an abutment according to any one of claim 1 that can be connected to the main part.
